(19) United States
(12) Patent Application Publication
(10) Pub. No.: US 2025/0314758 A1
(43) Pub. Date: Oct. 9, 2025

(54) METHOD FOR MONITORING THE INNER SPACE OF A VEHICLE, CONTROL UNIT, AND SENSOR DEVICE

(71) Applicant: HELLA GMBH & CO. KGAA, Lippstadt (DE)

(72) Inventors: Etienne Costa-Patry, Berlin (DE); Esakki Ponraj Esakkimuthu, Berlin (DE)

(21) Appl. No.: 19/096,892

(22) Filed: Apr. 1, 2025

(30) Foreign Application Priority Data
Apr. 3, 2024 (DE) 102024109250.5

(51) Int. Cl. G01S 13/56; G01S 7/41; G01S 13/02

(52) U.S. Cl. CPC G01S 13/56; G01S 7/415; G01S 13/0209

(57) ABSTRACT

The invention relates to a method for monitoring an inner space of a vehicle using a sensor device, in particular an ultra-wideband (UWB) sensor device. The sensor device has a first sensor unit and a second sensor unit. The first sensor unit includes a first antenna and a second antenna which have different sensitivities and which are arranged at known positions and at a known distance from one another. The second sensor unit comprises a first antenna and a second antenna which have different sensitivities and which are arranged at known positions and at a known distance from one another. Information from various antennas is taken into account when monitoring the inner space of the vehicle in order to provide a presence detection in the inner space of the vehicle.

### CROSS-REFERENCE TO RELATED APPLICATIONS

The present application claims the benefit of German Patent Application No. 10-2024-109-250.5, filed Apr. 3, 2024, the disclosure of which is incorporated by reference.

### FIELD OF THE INVENTION

The invention relates to a method for monitoring the inner space of a vehicle using a sensor device, in particular an ultra-wideband (UWB) sensor device. Furthermore, the invention relates to a corresponding computer program product, a corresponding control unit, and a corresponding sensor device, in particular a UWB sensor device, for carrying out a corresponding method.

### BACKGROUND OF THE INVENTION

UWB sensor units are increasingly being installed in modern vehicles. The UWB sensor units can be used to detect people in the inner space of the vehicle. The UWB sensor units can detect the transit time of sensor signals reflected by people who are in the inner space of the vehicle. The transit time of the sensor signals can be used to determine the distance to the persons. The Doppler shift of the sensor signals can be used to detect a person's movements, e.g. when breathing, so that their chest moves. Furthermore, vital parameters of the person, such as breathing rate, can be determined. The disadvantage of the known sensor units is that the detection is often inaccurate and associated with errors.

It is therefore the object of the present invention to at least partially overcome at least one of the disadvantages described above. In particular, it is the object of the invention to provide an improved method for monitoring the inner space of a vehicle using a sensor device, in particular a UWB sensor device, which enables improved presence detection in the inner space of the vehicle, which has improved accuracy, which enables improved monitoring functions, which increases customer comfort and which increases confidence in the monitoring method. Furthermore, it is an object of the present invention to provide a corresponding computer program product, a corresponding sensor device, in particular a UWB sensor device, for carrying out a corresponding method.

### SUMMARY OF THE INVENTION

The present invention provides a method for monitoring an inner space of a vehicle using a sensor device, in particular a UWB sensor device. Furthermore, the invention provides for a corresponding computer program product, a corresponding control unit and a corresponding sensor device, in particular a UWB sensor device. In this context, features and details described in connection with the various embodiments and/or aspects of the invention naturally also apply in connection with the other embodiments and/or aspects and vice versa in each case, so that reference is or can always be made reciprocally with respect to the disclosure relating to the individual embodiments and/or aspects.

The present invention provides a method for monitoring the inner space of a vehicle using a sensor device, in particular a UWB sensor device.

The sensor device has a first sensor unit and a second sensor unit, wherein the first sensor unit has (at least) a first antenna and a second antenna (or several antennas) which have different sensitivities (or resolutions) and which are arranged at known positions and/or at a known distance from one another, wherein the second sensor unit has (at least) a first antenna and a second antenna (or several antennas) which have different sensitivities (or resolutions) and which are arranged at known positions and at a known distance from one another.

It is provided that information from various antennas is taken into account when monitoring the inner space of a vehicle in order to provide improved presence detection, in particular small child presence detection, in the interior of the vehicle.

The two (UWB) sensor units can be arranged on a roof. The first (UWB) sensor unit can be located at the front and the second (UWB) sensor unit at the rear of the vehicle.

The two (UWB) sensor units can both transmit and receive.

Each (UWB) sensor unit can comprise at least two or more antennas.

Advantageously, the antennas within a (UWB) sensor unit can have different sensitivities or resolutions (especially in terms of range). One antenna in a (UWB) sensor unit may have a comparatively higher sensitivity than the other antenna.

The invention recognizes that antennas with different sensitivities can detect differently pronounced movements. In a newborn sleeping in a car seat, the chest only moves a few millimeters when breathing. In order to detect these small movements, an antenna must have a correspondingly high resolution to detect movements of a few millimeters. In the case of small children, who also make somewhat larger movements of a few millimeters when breathing, several antennas can react to the movements with a correspondingly high resolution. In the case of an adult, even antennas that have a comparatively low resolution, e.g. in the area of several millimeters and/or in the centimeter range, can provide detection.

The invention thus recognizes that if several, in particular all, antennas with different sensitivities or resolutions (high, e.g. in the millimeter range, or low resolutions, e.g. in the area of several millimeters and/or in the centimeter range) detect a person, then it is very likely to be an adult.

Presence detection, especially small child presence detection, can be particularly advantageous if babies, small children or even animals are unintentionally left behind in parked vehicles. This can be particularly dangerous in summer.

Presence detection can be used to warn a vehicle user if children or animals remain in the vehicle after leaving it.

The proposed method can be used to avoid false alarms if, for example, an adult remains in the vehicle. An adult is very likely to remain in the vehicle consciously. In addition, an adult can usually leave the vehicle themselves.

The method can be used to safely and reliably distinguish between people of different ages and/or sizes.

If several, in particular all, antennas on the sensor device sense a person, then it can be assumed that the person in the vehicle is an adult. In this case, warnings may be omitted.

Furthermore, it may be provided that the sensitivities of different antennas are taken into account when monitoring the inner space of a vehicle in order to detect people of different ages and/or sizes in the interior of the vehicle. A number of antennas with comparatively high resolution (e.g. in the millimeter range) can be used to determine when a newborn (e.g. only one antenna with high resolution provides a signal for a positive detection) or a small child (e.g. two antennas with high resolution provide signals for a positive detection) is detected. For adults or relatively tall people, even antennas with comparatively low resolutions (e.g. in the area of several millimeters and/or centimeters) can detect a person. In this manner, the method can enable improved recognition of people of different ages and/or sizes.

Advantageously, at least one (or only one) antenna with such (comparatively high) sensitivity can be provided to detect newborns in the inner space of the vehicle.

For example, at least one antenna, preferably two antennas, with such (comparatively high) sensitivity can be provided to detect small children in the inner space of the vehicle.

Advantageously, it may be provided that at least two antennas, preferably three antennas, preferably four antennas, are provided with such (comparatively low) sensitivity to detect adults in the inner space of the vehicle.

Furthermore, threshold values can be provided for how many, in particular all, antennas should detect a presence in order to detect an adult in the inner space of the vehicle, and in particular to avoid false alarms during presence detection, especially in the case of child presence detection. In other words, if even those antennas that have comparatively low sensitivity detect a presence, then it can be assumed that an adult has been detected.

Furthermore, the positions of various antennas can be taken into account when monitoring the inner space of a vehicle in order to localize people in the vehicle. Angles of incidence at the antennas can be examined and the positions of the persons can be determined using Euclidean equations.

Furthermore, when monitoring the inner space of a vehicle, the distances of various antennas can be taken into account in order to localize people in the inner space of the vehicle. Angles of incidence at the antennas can also be examined and the positions of the persons can be determined using Euclidean equations. In addition, the distances between different antennas can enable corresponding angular resolutions so that different antennas can specifically monitor different areas in the inner space of the vehicle.

Advantageously, the method, in particular an analysis of sensor signals, can be carried out using a machine learning method. Machine learning methods are particularly suitable for evaluating sensor signals, enabling fast and computationally simple acquisition with low memory requirements.

The present invention also provides a computer program product comprising commands which, when the computer program product is carried out by a computer, cause the computer to carry out a method which may be as described above. The computer program product can be used to achieve the same advantages described above in connection with the method according to the invention. Full reference is made to these advantages in the present case.

The present invention also provides a control unit (ECU), having a computing unit and a storage unit in which a code is stored which, when at least partially carried out by the computing unit, carries out a method which can run as described above. By means of the control unit (ECU), the same advantages described above in connection with the method according to the invention can be achieved. Full reference is made to these advantages in the present case.

The present invention also provides a sensor device, in particular a UWB sensor device, wherein the sensor device comprises a first sensor unit and a second sensor unit, wherein the first sensor unit has a first antenna and a second antenna which have different sensitivities and which are arranged at known positions and at a known distance from one another, wherein the second sensor unit comprises a first antenna and a second antenna which have different sensitivities and which are arranged at known positions and at a known distance from one another, and wherein the sensor device comprises a control unit which is configured to take information from different antennas into account when monitoring the inner space of a vehicle in order to provide a presence detection PE in the inner space of the vehicle. The control unit can advantageously be specially embodied to carry out a method which can run as described above. The receiving unit can be used to achieve the same advantages as described above in connection with the method according to the invention. Full reference is made to these advantages in the present case.

### BRIEF DESCRIPTION OF THE DRAWINGS

The invention is explained in more detail in the attached drawings. In the figures:

FIG. 1 is an exemplary representation of a sensor device; and

FIG. 2 is an exemplary visualization of a sensor detection.

### DETAILED DESCRIPTION OF THE CURRENT EMBODIMENT

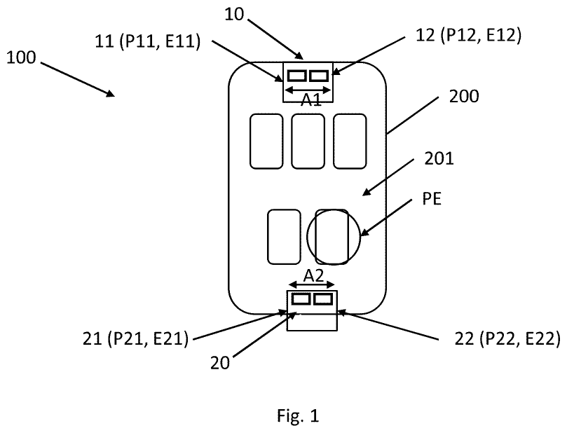

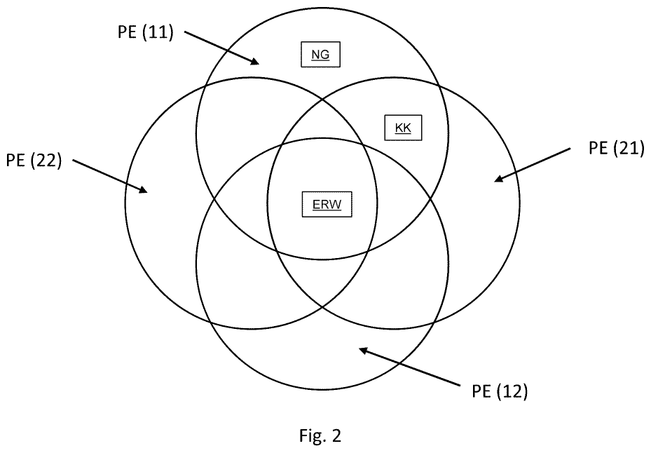

FIGS. 1 and 2 serve to explain a method within the meaning of the invention, which was developed for monitoring the inner space of a vehicle using a sensor device, in particular an ultra-wideband (UWB) sensor device.

As indicated by FIGS. 1 and 2, the sensor device 100 comprises a first sensor unit 10 and a second sensor unit 20, wherein the first sensor unit 10 comprises at least a first antenna 11 and a second antenna 12 or a plurality of antennas which have different sensitivities E11, E12 or resolutions and which are arranged at known positions P11, P12 and/or at a known distance A1 from one another, wherein the second sensor unit 20 comprises at least a first antenna 21 and a second antenna 22 or a plurality of antennas which have different sensitivities E21, E22 or resolutions and which are arranged at known positions P21, P22 and at a known distance A2 from one another.

Advantageously, when monitoring the inner space of a vehicle 200 information (comprising, for example: sensor signals, antenna parameters, such as sensitivity, antenna positions, antenna spacing, etc.) from various antennas 11, 12, 21, 22 are taken into account when monitoring the inner space of a vehicle 200 to provide improved presence detection, in particular infant presence detection, in the inner space 201 of the vehicle 200.

The two UWB sensor units 10, 20 can be arranged on a roof. The first UWB sensor unit 10 can be arranged at the front and the second UWB sensor unit at the rear of the vehicle 200.

The two UWB sensor units 10, 20 can both transmit and receive.

Each UWB sensor unit 10, 20 may comprise at least two or more antennas.

For example, it is conceivable that an antenna 11, 21 within a UWB sensor unit 10, 20 can both transmit and receive, and/or that another antenna 12, 22 within a UWB sensor unit 10, 20 can both transmit and receive or only receive.

Advantageously, the antennas 11, 12 or 21, 22 within a UWB sensor unit may have different sensitivities E11, E12, E21, E22 or resolutions, in particular with regard to range. Here, one antenna 11, 21 in a UWB sensor unit may have a comparatively higher sensitivity E11, E21 than the other antenna 12, 22.

The invention recognizes that antennas 11, 12, 21, 22 with different sensitivities E11, E12, E21, E22 can be used to detect differently pronounced movements.

In a newborn NG sleeping in a car seat, the chest only moves a few millimeters

when breathing. In order to detect these small movements, an antenna 11 or 21 must have a correspondingly high resolution to detect movements of a few millimeters.

In the case of small children KK, who also make somewhat larger movements of a few millimeters when breathing, several antennas 11 and 21 can respond to the movements with a correspondingly high resolution.

In the case of an adult ERW, even antennas 11, 12, 21, 22 can provide detection that have a comparatively low resolution, which can be in the area of several millimeters and/or even in the centimeter range, for example.

The invention now suggests that if several, in particular all, antennas 11, 12, 21, 22 with different sensitivities E11, E12, E21, E22 or resolutions (high, e.g. in the millimeter range, and/or low resolutions, e.g. in the area of several millimeters and/or in the centimeter range) detect a person, then it is very likely that the person is an adult ERW.

Presence detection, in particular small child presence detection, can be particularly advantageous if newborns NG, small children KK or animals are unintentionally left behind in parked vehicles 200. This can be particularly dangerous in summer.

A presence detection PE can be used to warn a user of the vehicle 200 in good time if newborn NG, small children KK or animals remain in the vehicle 200 after leaving it.

To avoid false alarms if, for example, an adult ERW remains in the vehicle 200, this is probably done deliberately. An adult ERW is normally able to leave the vehicle by himself.

Using this method, a safe and reliable distinction can be made between people of different ages and/or sizes, in particular between newborns NG, small children KK and adults ERW.

If several, in particular all, antennas 11, 12, 21, 22 on the sensor device 100 sense a person, then it can be assumed that the person in the vehicle 200 is an adult ERW. In this case, warnings can be omitted in order to reduce false alarms.

When monitoring the inner space 201 of a vehicle 200, in particular the sensitivities E11, E12, E21, E22 of different antennas 11, 12, 21, 22 can be taken into account in order to detect persons of different ages and/or sizes in the inner space 201 of the vehicle 200.

An individual number of antennas 11, 12, 21, 22 can be determined for different

age groups and/or sizes.

An antenna 11 and/or 21 with comparatively high resolution, e.g. in the millimeter range, can detect a newborn NG.

Two antennas 11 and 21 with comparatively high resolution, e.g. in the millimeter range, can detect a small child KK.

For adults ERW or relatively tall people, even antennas 12, 22 with comparatively low resolutions, e.g. in the area of several millimeters and/or in the centimeter range, can detect a person.

Advantageously, threshold values can be provided to differentiate between newborns NG, small children KK and adults ERW.

Furthermore, when monitoring the inner space of a vehicle 200, the positions P11, P12, P21, P22 and/or distances A1, A2 of various antennas 11, 12, 21, 22 can be taken into account in order to localize persons in the inner space 201 of the vehicle 200. The angle of incidence at the antennas 11, 12, 21, 22 can be examined and the positions of the persons can be determined using Euclidean equations.

Advantageously, the method can carry out an analysis of sensor signals using machine learning methods.

Furthermore, the invention relates to a corresponding computer program product, a corresponding control unit ECU and a corresponding sensor device 100, in particular a UWB sensor device, for carrying out a corresponding method.

The foregoing explanation of embodiments describes the present invention by way of example only. Of course, individual features of the embodiments may be freely combined with one another, provided that this is technically expedient, without departing from the scope of the present invention.

### LIST OF REFERENCE NUMERALS

100 sensor device
10 sensor unit
11 antenna
12 antenna
A1 distance
P11 position
P12 position
E11 sensitivity
E12 sensitivity
20 sensor unit
21 antenna
22 antenna
A2 distance
P21 position
P22 position
E21 sensitivity
E22 sensitivity
NG newborn
KK small child
ERW adult
200 vehicle
201 interior space
PE presence detection
ECU control unit

1. A method for monitoring an interior space of a vehicle with an ultra-wideband (UWB) sensor device, wherein the UWB sensor device has a first sensor unit and a second sensor unit, wherein the first sensor unit comprises a first antenna and a second antenna which have different sensitivities and which are arranged at known positions and at a known distance from one another, wherein the second sensor unit comprises a first antenna and a second antenna which have different sensitivities and which are arranged at a known distance from one another, the method comprising providing a presence detection in the interior space of the vehicle based on information from the first and second antennas of the first sensor unit and based on information from the first and second antennas of the second sensor unit.

2. The method according to claim 1, wherein the sensitivities of the first and second antennas of the first sensor unit and the first and second antennas of the second sensor unit are taken into account when monitoring the interior space of the vehicle in order to detect persons of different ages or sizes in the interior space of the vehicle.

3. The method according to claim 1, wherein at least one antenna is configured to detect a newborn in the interior space of the vehicle.

4. The method according to claim 1, wherein at least one antenna is configured to detect small children in the interior space of the vehicle.

5. The method according to claim 1, wherein at least one antenna is configured to detect adults in the interior space of the vehicle.

6. The method according to claim 1, wherein threshold values are provided as to how many antennas are to detect a presence in order to detect an adult in the interior space of the vehicle to avoid false alarms during child presence detection.

7. The method according to claim 1, wherein providing a presence detection is further based on positions of the first and second antennas of the first sensor unit and positions of the first and second antennas of the second sensor unit.

8. The method according to claim 1, wherein providing a presence detection is further based on a distance separating the first and second antennas of the first sensor unit and a distance separating the first and second antennas of the second sensor unit.

9. The method according to claim 1, wherein providing a presence detection is carried out using machine learning.

10. A computer program comprising commands which, when executed by a computer, cause the computer to carry out the method according to claim 1.

11. A control unit having a computing unit and a storage unit containing machine readable instructions that, when executed by the computing unit, cause the computing unit to carry out the method according to claim 1.

12. An ultra-wideband (UWB) sensor device comprising:
a first sensor unit and a second sensor unit, wherein the first sensor unit comprises a first antenna and a second antenna which have different sensitivities and which are arranged at known positions and at a known distance from one another, wherein the second sensor unit comprises a first antenna and a second antenna which have different sensitivities and which are arranged at known positions and at a known distance from one another, the UWB sensor device further comprising a control unit which is coupled to the first and second antennas of the first sensor unit and the first and second antennas of the second sensor unit, the control unit being configured to monitor an interior space of a vehicle in order to provide a presence detection based on information from the first and second antennas of the first sensor unit and based on information from the the first and second antennas of the second sensor unit.

13. The sensor device according to claim 12, wherein the control unit is configured to detect each of a newborn, a small child, and an adult in the interior space of the vehicle.
